(19) United States
(12) Patent Application Publication
(10) Pub. No.: US 2009/0144354 A1
(43) Pub. Date: Jun. 4, 2009

(54) IMAGING DEVICE

(75) Inventors: Kaori Misawa, Kaizu-shi (JP); Ryu Shimizu, Mizuho-shi (JP); Mamoru Arimoto, Ogaki-shi (JP); Hayato Nakashima, Gifu-ken (JP)

Correspondence Address: DITTHAVONG MORI & STEINER, P.C., 918 Prince St., Alexandria, VA, 22314, US

(73) Assignee: Sanyo Electric Co., Ltd, Moriguchi-shi (JP)

(21) Appl. No.: 12/324,225

(22) Filed: Nov. 26, 2008

(30) Foreign Application Priority Data
Nov. 30, 2007 (JP) 2007-309612

(51) Int. Cl. G06G 7/16

(52) U.S. Cl. 708/838

(57) ABSTRACT

An imaging device that improves properties for multiplying signal charges. The imaging device includes an accumulation section which accumulates signal charges. A transfer section transfers the signal charges accumulated in the accumulation section. A multiplier section increases the signal charges accumulated in the accumulation section. The transfer section includes a first insulating member arranged on a substrate and a first electrode arranged on the first insulating member. The multiplier section includes a second insulating member arranged on the substrate and a second electrode arranged on the second insulating member. The second insulating member has a thickness which is greater than that of the first insulating member.

### CROSS-REFERENCE TO RELATED APPLICATIONS

This application claims the benefit of Japanese Patent Application No. 2007-309612, filed on Nov. 30, 2007, the entire contents of which are incorporated herein by reference.

### BACKGROUND OF THE INVENTION

The present disclosure relates to an imaging device, and more particularly, to an imaging device including a multiplier section for multiplying electrons.

A complementary metal oxide semiconductor (CMOS) image sensor, which includes a multiplier section for multiplying electrons, is known as an imaging device in the prior art.

FIG. 6 is a cross-sectional view of a CMOS image sensor described in Japanese Laid-Open Patent Publication No. 2007-235097. The CMOS image sensor includes a photodiode (PD) 104, which functions to perform photoelectric conversion and which accumulates electrons produced by the photoelectric conversion. A multiplier section 131 includes a multiplication gate electrode 109, which generates an electric field that causes impact ionization to multiply electrons. A transfer gate electrode 108 is arranged between the photodiode 104 and the multiplication gate electrode 109. The transfer gate electrode 108 is adjacent to the photodiode 104 and multiplication gate electrode 109. The transfer gate electrode 108 and the multiplication gate electrode 109 are formed on a silicon insulation film 107, which is applied to a p-type silicon substrate 101. In a state in which voltage is applied, the transfer gate electrode 108 (i.e., a transfer channel 103 under the multiplication gate electrode 109) transfers electrons between the photodiode 104 and the multiplier section 131. In a state in which high voltage (i.e., voltage for causing impact ionization to multiply ions) is applied to the multiplication gate electrode 109, a high electric field region 103a to which high voltage is applied is formed at the boundary between the transfer channel 103 under the transfer gate electrode 108, and the transfer channel 103 under the multiplication gate electrode 109. The impact ionization caused by the high electric field of the high electric field region 103a results in the multiplier section 131 increasing (multiplying) the transferred electrons.

In the CMOS image sensor, voltage that enables electrons to be multiplied by impact ionization is applied to the multiplication gate electrode 109. Then, the voltage at the transfer gate electrode 108 is controlled to transfer electrons from the photodiode 104 to the multiplier section 131. As a result, the photodiode 104 transfers the accumulated electrons to the multiplier section 131, which multiplies the electrons. Further, the voltage applied to each of the transfer gate electrode 108 and the multiplication gate electrode 109 is controlled so as to return the electrons multiplied by impact ionization. Then, the voltage at the transfer gate electrode 108 is controlled so that the electrons returned to the photodiode 104 from the multiplier section 131 are transferred again to the multiplier section 131.

In the CMOS image sensor shown in FIG. 6, the execution of control in such a manner enables the multiplication of electrons caused by impact ionization to be performed a number of times. Further, this improves the electron multiplication factor. Thus, the quantity of electrons produced by the photodiode 104, which functions to perform photoelectric conversion, is effectively increased.

In the CMOS image sensor of FIG. 6, the electron multiplication operation, which can be performed a number of times, may improve the multiplication property (i.e., multiplication factor of electrons) to a certain extent. However, due to the recent tendency for cameras having higher sensitivity, further improvement of the multiplication property is required. Moreover, improvement in the imaging speed of a CMOS image sensor is also required. Accordingly, the multiplication property must be improved without increasing the electron multiplication operations in order to prevent the imaging speed of a CMOS image sensor from decreasing.

The present invention provides an imaging device that improves the properties for multiplying signal charges.

One aspect of the present invention is an imaging device including an accumulation section which accumulates signal charges. A transfer section transfers the signal charges accumulated in the accumulation section. A multiplier section increases the signal charges accumulated in the accumulation section. The multiplier section is arranged opposite to the accumulation section from the transfer section. The transfer section includes a first insulating member arranged on a substrate and a first electrode arranged on the first insulating member. The multiplier section includes a second insulating member arranged on the substrate and a second electrode arranged on the second insulating member. The second insulating member has a thickness which is greater than that of the first insulating member.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic plan view showing a first embodiment of a CMOS image sensor according to the present invention;

FIG. 2(A) is a partial cross-sectional view showing an imaging portion in the CMOS image sensor of FIG. 1;

FIG. 2(B) is a partial cross-sectional view showing a peripheral circuit in the CMOS image sensor of FIG. 1;

FIG. 3 is a circuit diagram of the CMOS image sensor of FIG. 1;

FIG. 4 is a partial cross-sectional view of a second embodiment of a CMOS image sensor according to the present invention;

FIG. 5 is a partial cross-sectional view of a third embodiment of a CMOS image sensor according to the present invention; and

FIG. 6 is a schematic cross-sectional view of a prior art CMOS image sensor.

### DETAILED DESCRIPTION OF THE PREFERRED EMBODIMENTS

Several embodiments of the present invention will now be discussed with reference to the drawings. To avoid redundancy, like or same reference numerals are given to those components that are the same or similar in the embodiments.

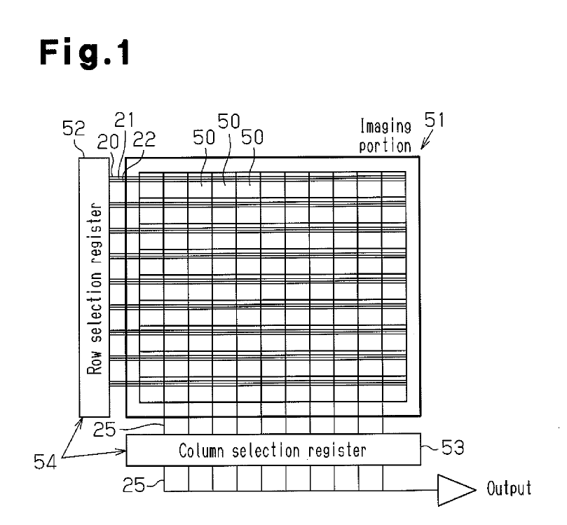

With reference to FIGS. 1 to 3, a first embodiment of a CMOS image sensor according to the present invention will now be described. In this embodiment, the CMOS image sensor is of a passive type and is one example of an imaging device according to the present invention.

The planar structure of a pixel 50 in the CMOS image sensor will now be discussed with reference to FIG. 1. The CMOS image sensor includes an imaging portion 51 and a peripheral circuit 54. The imaging portion 51 includes a matrix (rows and columns) of pixels 50. The peripheral circuit 54 includes a row selection register 52, a column selection register 53, and a signal processing circuit (not shown), which is arranged near the imaging portion 51.

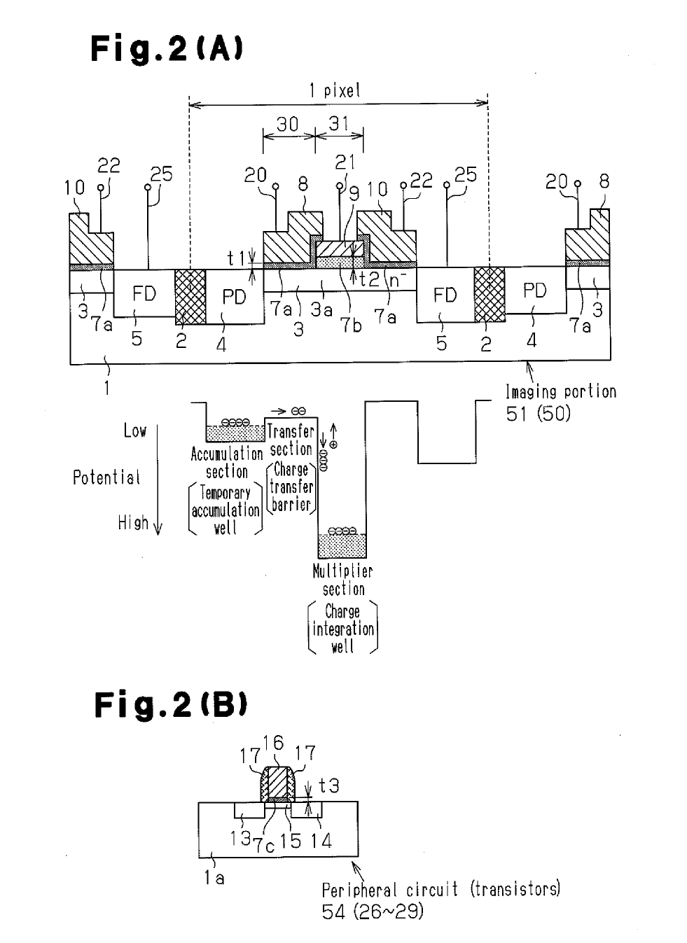

With reference to FIG. 2, the cross-sectional structure of a pixel 50 in the CMOS image sensor will now be discussed. The image sensor includes a p-type silicon substrate 1 having a surface with device isolation regions 2 that isolate the pixels 50 from one another. A photodiode (PD) 4 and a floating diffusion region (FD) 5 are formed in the surface of the p-type silicon substrate 1 for each pixel 50, which is surrounded by the associated device isolation region 2. The photodiode 4 and the floating diffusion region 5 are spaced apart by a predetermined distance. A transfer channel 3 extends between the photodiode 4 and the floating diffusion region 5.

Each device isolation region 2 is formed between the photodiode 4 of one pixel 50 and the floating diffusion region 5 of the adjacent pixel 50. The device isolation region 2 prevents electrons produced by the photodiode 4 from entering the floating diffusion region 5 in the adjacent pixel 50.

The transfer channel 3 functions as a signal path and is located near the surface of the p-type silicon substrate (specifically, slightly lower than the substrate surface).

The photodiode 4 produces electrons in accordance with the amount of incident light and accumulates the produced electrons. The photodiode 4 is formed adjacent to the device isolation region 2 and the transfer channel 3.

The floating diffusion region 5 is formed, for example, from an n⁺ type impurity region. The impurity concentration (n⁺) of the floating diffusion region is higher than the impurity concentration (n⁻) of the transfer channel 3. The floating diffusion region 5 holds a charge signal of the transferred electrons and converts the charge signal to voltage. Further, the floating diffusion region 5 is formed adjacent to the device isolation region 2 and the transfer channel 3 opposite to the photodiode 4. That is, the floating diffusion region 5 faces toward the photodiode 4 with the transfer channel 3 located in between.

A transfer gate electrode 8, a multiplication gate electrode 9, and a read gate electrode 10 are sequentially formed from the photodiode 4 toward the floating diffusion region 5 on the upper surface of the transfer channel 3. The transfer gate electrode 8 is formed adjacent to the photodiode 4. The transfer gate electrode 8 is formed between the photodiode 4 and the multiplication gate electrode 9. The multiplication gate electrode 9 and photodiode 4 are formed on opposite sides of the transfer gate electrode 8. The read gate electrode 10 is formed between the multiplication gate electrode 9 and the floating diffusion region 5. Further, the read gate electrode 10 is formed adjacent to the floating diffusion region 5.

The transfer gate electrode 8 is formed on the upper surface of the p-type silicon substrate 1 (particularly, the upper surface of the transfer channel 3) with a first insulation film 7a formed in between. When a predetermined voltage (for example, 5.0 V) is applied, the transfer gate electrode 8 transfers the electrons accumulated in the photodiode 4 to the transfer channel 3 under the multiplication gate electrode 9 and also transfers the electrons multiplied by the transfer channel 3 under the multiplication gate electrode 9 to the photodiode 4. The transfer gate electrode 8, the first insulation film 7a, and the transfer channel 3, which is located under transfer gate electrode 8, form a transfer section 30. When voltage is applied to the transfer gate electrode 8, the transfer channel 3 under the transfer gate electrode 8 functions as an embedded channel that forms a path through which charge moves in the p-type silicon substrate 1 (slightly lower than the substrate surface). Generally, such an embedded channel is an n⁻ type impurity region formed by doping the vicinity of a surface located immediately below a gate electrode with n-type impurities, the type of which is opposite the p-type silicon substrate.

The multiplication gate electrode 9 is formed on the upper surface of the p-type silicon substrate 1 (particularly, the upper surface of the transfer channel 3) with a second insulation film 7b arranged in between. When a predetermined voltage (i.e., voltage that generates an electric field causing impact ionization of electrons, for example, about 24 V) is applied, the multiplication gate electrode 9 adjusts the potential to be high at the transfer gate under the multiplication gate electrode 9. This forms the high electric field region 3a, to which a high electric field is applied, at the boundary between the transfer channel 3 under the transfer gate electrode 8 and the transfer channel 3 under the multiplication gate electrode 9. When the electrons accumulated in the photodiode 4 are transferred and reach the high electric field region 3a, the high electric field generated in the high electric field region 3a causes impact ionization and multiplies the transferred electrons. The multiplication gate electrode 9, the second insulation film 7b, and the transfer channel 3 under the multiplication gate electrode 9 form a multiplier section 31.

The read gate electrode 10, which has the same structure as the transfer gate electrode 8, is formed on the upper surface of the p-type silicon substrate 1 (particularly, on the upper surface of the transfer channel 3 with the first insulation film 7a arranged in between. When a predetermined voltage (for example, 5.0 V) is applied, the read gate electrode 10 transfers the charge signal of the electrons multiplied by the high electric field region 3a to the floating diffusion region 5, which is for reading the charge signal as a voltage signal.

The first insulation film 7a is formed between the p-type silicon substrate 1 and transfer gate electrode 8 and between the p-type silicon substrate 1 and the read gate electrode 10. Further, the first insulation film 7a covers the side surfaces and part of the upper surface of the multiplication gate electrode 9. The first insulation film 7a insulates the transfer gate electrode 8 from the multiplication gate electrode 9. The first insulation film 7a also insulates the multiplication gate electrode 9 from the read gate electrode 10. A laminated film including a silicon oxide film (thermal silicon oxide film) formed through thermal oxidation and a silicon oxide film formed through a CVD process may be used as the first insulation film 7a. The laminated film has thickness t1 (for example, about 35 nm) on the upper surface of the p-type silicon substrate 1. In the first embodiment, when voltage is applied to the transfer gate electrode 8 (or the read gate electrode 10), some of the transferred electrons may be caught at an interface state between the p-type silicon substrate 1 and the first insulation film 7a. This may result in loss of the signal charge. To prevent such signal charge loss, the thickness t1 of the first insulation film 7a and the voltage applied to the transfer gate electrode 8 (or the read gate electrode 10) are controlled so that the transfer channel 3 functions as an embedded channel. More specifically, when the voltage applied to the transfer gate electrode 8 (or the read gate electrode 10) is about 5.0 V, under the condition that the transfer channel 3 functions as an embedded channel while ensuring the insulation withstand voltage (5 MV/cm or greater), the thickness t1 of the first insulation film 7a may be set to about 35 nm. When the first insulation film 7a is too thick (for example, when the thickness t1 is about 50 nm), the insulation withstand voltage is ensured. However, the potential at the transfer channel 3 cannot be varied. This lowers controllability during a transfer operation (on/off control during a transfer).

The second insulation film 7b is formed between the p-type silicon substrate 1 and the multiplication gate electrode 9. A monolayer film, which is a silicon oxide film (thermal silicon oxide film) formed through thermal oxidation, may be used as the second insulation film 7b. The monolayer film has thickness t2 (for example, about 50 nm), which is greater than the thickness t1 (for example, 35 nm) of the first insulation film 7a. In the first embodiment, when the voltage applied to the multiplication gate electrode 9 is about 24 V, under the condition that the thickness of the second insulation film 7b is minimized so that potential at the multiplier section 31 can be obtained at a deep position while ensuring the insulation withstand voltage (5 MV/cm or greater) of the second insulation film 7b, the thickness t2 of the second insulation film 7b may be set to about 50 nm.

When the second insulation film 7b is too thick (for example, when the thickness t2 is about 150 nm), the withstand voltage is ensured. However, a multiplication potential cannot be generated in the transfer channel 3. This adversely affects the charge multiplication property. On the other hand, when the second insulation film 7b is too thin (for example, about 35 nm), the insulation withstand voltage is too low since a high voltage is applied to the multiplication gate electrode 9 (voltage for generating an electric field that causes impact ionization of electrons). In this case, even if the withstand voltage were to be ensured, some of the transferred electrons would be injected into the second insulation film 7b and become easily caught. This would reduce the electrons transferred to the multiplier section 31, and variations in the multiplication property (decrease in multiplication factor) would occur between multiplication operations.

Accordingly, it is preferable that the thickness t2 of the second insulation film 7b be within a range of about 50 nm to about 130 nm. When the applied voltage is lowered to ensure the insulation withstand voltage, the multiplication potential well becomes too shallow. This would decrease the multiplication factor.

In the first embodiment, the thickness t2 of the second insulation film 7b is greater than the thickness t1 of the first insulation film 7a. Due to this thickness relationship, while applying voltage to the transfer gate electrode 8 so that the transfer channel 3 functions as an embedded channel in the transfer section 30, electrons are multiplied in the multiplier section 31 by applying high voltage to the multiplication gate electrode 9 (voltage for generating an electric field that causes impact ionization of electrons). Accordingly, the transfer channel 3 functions as an embedded channel and thus prevents electrons transferred when voltage is applied to the transfer gate electrode 8 from being caught in the interface between the p-type silicon substrate 1 and the first insulation film 7a. Furthermore, the electric field generated at the interface between the p-type silicon substrate 1 and the first insulation film 7a when applying high voltage to the multiplication gate electrode 9 (voltage for generating an electric field that causes impact ionization of electrons) is weakened for an amount corresponding to at least the increase in thickness from the first insulation film 7a to the second insulation film 7b. Thus, such an electric field prevents the transferred electrons from being injected into the second insulation film 7b and becoming caught therein.

As described above, the reduction of electrons during transfer operations is prevented, and electrons are effectively increased during multiplication operations. Therefore, the electron multiplication property is improved in the multiplier section 31 of the CMOS image sensor.

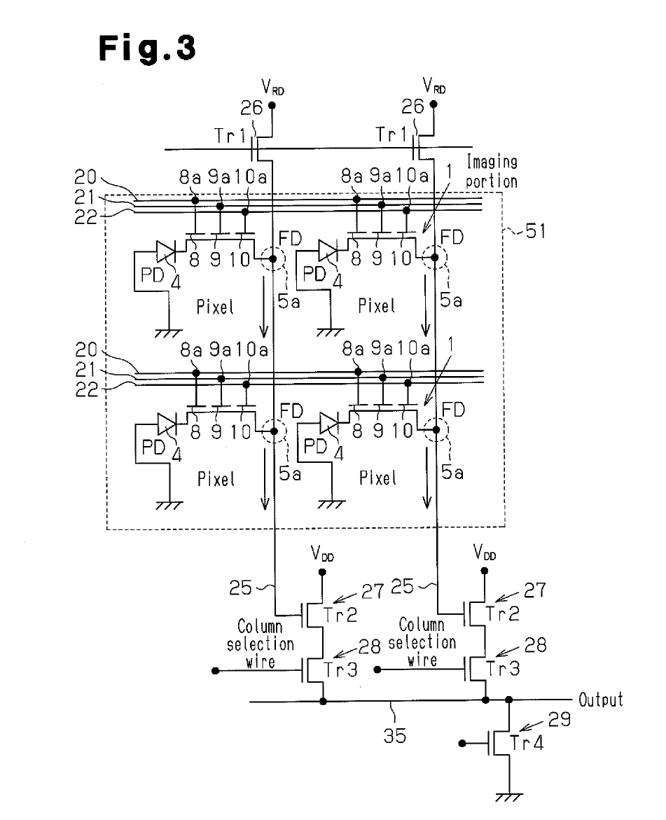

Further, as shown in FIG. 1, in the CMOS image sensor of the first embodiment, wiring layers 20, 21, and 22 are electrically connected to the row selection register 52 to provide a voltage control clock signal to each row of the pixels 50 in the imaging portion 51. A signal wire 25 is electrically connected to the column selection register 53 to extract a signal from each column of the pixels 50. As shown in FIG. 3, the wiring layers 20, 21, and 22 are respectively connected to the transfer gate electrode 8, the multiplication gate electrode 9, and the read gate electrode 10 via contacts 8a, 9a, and 10a. The signal wire 25 is connected to the floating diffusion region 5 via a contact 5a.

In the peripheral circuit 54, which includes the row selection register 52 and the column selection register 53, every predetermined number of pixels is connected to a reset gate transistor 26, a selection transistor 28, and a transistor of a source follower circuit.

More specifically, as shown in FIG. 3, one end of the signal wire 25 for each column is connected to the source of a reset gate transistor 26 (Tr1). The reset gate transistor 26 has a gate provided with a reset signal and a drain to which a reset voltage V_{RD} (about 2.5 V) is applied. Thus, after reading data from the pixels 50, the reset gate transistor 26 resets the voltage of the signal wire 25 to the reset voltage V_{RD} (about 2.5 V). When reading data from the pixels 50, the reset gate transistor 26 holds the floating diffusion region 5 in an electrical floating state.

The other end of the signal wire 25 for each column is connected to the gate of a voltage conversion transistor 27. The source of the voltage conversion transistor 27 is connected to the drain of a selection transistor 28 (Tr3). The voltage conversion transistor 27 is supplied with power supply voltage (about 2.5 V). The selection transistor 28 has a gate connected to a column selection wire and a source connected to an output wire 35. The drain of a single transistor 29 (Tr4) is connected to the output wire 35. The transistor has a source connected to ground and a gate to which a predetermined voltage is applied so that the transistor 29 functions as a constant current source. The voltage conversion transistor 27 for each column and the single transistor 29 form a source follower circuit.

An MOS transistor such as that shown in FIG. 2(B) may be used as the transistors included in the peripheral circuit 54 (i.e., reset gate transistor 26, voltage conversion transistor 27, selection transistor 28, and transistor 29). The MOS transistor includes a source region 13 and a drain region 14 in a well region 1a, which is formed in the surface of the p-type silicon substrate 1. A control gate electrode 16 is formed on the upper surface of the well region 1a (channel layer 15) with a third insulation film 7c, which functions as a gate insulation film, arranged in between. A channel layer 15, which is a layer that is inverted when voltage is applied to the control gate electrode 16, is formed in the well region 1a between the source region 13 and the drain region 14. The channel layer 15 functions as a surface channel that forms a path through which charge moves in the surface of the p-type silicon substrate (well region 1a). An insulator (spacer insulator) 17 covers side wails of the control gate electrode 16 and side walls of the third insulation film 7c.

A monolayer film, which is a silicon oxide film (thermal silicon oxide film) formed through thermal oxidation, may be used as the third insulation film 7c. The monolayer film has thickness t3 (for example, about 50 nm). In the first embodiment, to increase the operational speed of the MOS transistor, the channel layer 15 functions as a surface channel that facilitates miniaturization of transistors. More specifically, when the voltage applied to the control gate electrode 16 is about 2.5 V, under the condition that the channel layer 15 functions as a surface channel while ensuring the insulation withstand voltage (5 MV/cm or greater) of the third insulation film 7c, the thickness t3 of the third insulation film 7c may be set to about 5 nm. When the third insulation film 7c is too thick (for example, when the thickness t3 is about 35 nm), for example, if the applied voltage is the same, the channel layer 15 cannot be formed in the well region 1a. This lowers controllability during a transfer operation (on/off control during a transfer). When the same voltage is applied to the transfer gate electrode 8, the withstand voltage of the gate insulation film would be insufficient. This would break the insulation.

In the first embodiment, the thickness t3 of the third insulation film 7c is less than the thickness t1 of the first insulation film 7a. This enables the transfer channel 3 to function as an embedded channel when applying voltage to the transfer gate electrode 8 in the transfer section 30, while the channel layer 15 functions as a surface channel 3 when applying voltage to the control gate electrode 16 in the transistors of the peripheral circuit 54 (i.e., reset gate transistor 26, voltage conversion transistor 27, selection transistor 28, and transistor 29). Accordingly, in the transfer section 30, the transfer channel 3 functions as an embedded channel. This prevents electrons transferred when voltage is applied to the transfer gate electrode 8 from being caught in the interface between the p-type silicon substrate 1 and the first insulation film 7a. Further, in each transistor of the peripheral circuit 54, the channel layer 15 functions as a surface channel and thus operates at a higher speed than the embedded channel in the pixels 50 (transfer channel 3).

The signal processing circuit (not shown) is arranged near the imaging portion 51. In the same manner as described above, a MOS transistor (surface channel type transistor) may be used as the transistors included in the signal processing circuit.

In the CMOS image sensor of the first embodiment, data is read by repeating operations for applying a predetermined voltage (e.g., 2.5 V) to each of the above-described transistors at predetermined timings.

The transfer and multiplication of electrons in the CMOS image sensor of the first embodiment are controlled in the same manner as described in Japanese Laid-Open Patent Publication No. 2007-235097, which is incorporated herein by reference.

The p-type silicon substrate 1 is one example of a “substrate” in the present invention, the photodiode 4 is one example of a “accumulation section” in the present invention, the multiplier section 31 is one example of a “multiplier section” in the present invention, the first insulation film 7a is one example of a “first insulating member” in the present invention, the transfer gate electrode 8 is one example of a “first electrode” in the present invention, the second insulation film 7b is one example of a “second insulating member” in the present invention, the multiplication gate electrode 9 is one example of a “second electrode” in the present invention, and the imaging portion 51 is one example of an “imaging portion” in the present invention. Further, the reset gate transistor 26, the voltage conversion transistor 27, the selection transistor 28, and the transistor 29 are each examples of a “transistor” in the present invention, the third insulation film 7c is one example of a “gate insulation film” in the present invention, the channel layer 15 is one example of a “channel layer” in the present invention, and the transfer gate electrode 8 is one example of a “transfer channel” in the present invention.

The imaging device (CMOS image sensor) of the first embodiment has the advantages described below.

(1) The thickness t2 of the second insulation film 7b under the multiplication gate electrode 9 in the multiplier section 31 is greater than the thickness t1 of the first insulation film 7a under the transfer gate electrode 8 in the transfer section 30. This prevents the electrons, which are multiplied when applying high voltage to the multiplication gate electrode 9 (voltage for generating an electric field that causes impact ionization of electrons), from being injected into and caught in the second insulation film 7b. Thus, multiplication operations effectively increase electrons. In this manner, the multiplier section 31 of the CMOS image sensor has an improved multiplication property (electron multiplication factor).

(2) The thickness t3 of the insulation film 7c under the control gate electrode 16 in each transistor of the peripheral circuit 54 (or each transistor of the signal processing circuit) is less than the thickness t1 of the first insulation film under the transfer gate electrode 8 in the transfer section 30. Thus, in comparison with the prior art (in which insulating members under the control gate electrode and the transfer gate electrode have the same thickness), the peripheral circuit 54 may perform operations (i.e., signal processing) at higher speeds. In this manner, the CMOS image sensor has an improved multiplication property (electron multiplication factor) and a higher operational speed.

(3) The use of a thermal silicon oxide film as the second insulation film decreases defects (charge capturing portions) in the film in comparison to when using a silicon oxide film that is formed through a CVD process. This prevents the electrons that are multiplied when applying high voltage to the multiplier section 31 (voltage for generating an electric field that causes impact ionization of electrons) from being injected into and caught in the second insulation film 7b. Thus, advantage (1) is obtained in a further significant manner.

(4) Voltage is applied to the control gate electrode 16, which is arranged on the upper surface of the p-type silicon substrate 1 with the third insulation film 3c arranged in between so as to form a surface channel type transistor. This easily increases the transistor operational speed. Thus, advantage (2) is obtained in a further significant manner.

(5) Voltage is applied to the transfer gate electrode 8, which is arranged on the upper surface of the p-type silicon substrate 1 with the first insulation film 7a arranged in between so as to form an embedded channel. This prevents the electrons that are transferred when applying voltage to the transfer section 30 from being caught in the interface between the p-type silicon substrate 1 and the first insulation film 7a. Thus, advantage (1) is obtained in a further significant manner.

(6) When alternately repeating the transfer of electrons for multiplication from the accumulation section (photodiode 4) to the multiplier section 31 and the transfer of electrons from the multiplier section 31 to the accumulation section (photodiode 4), the electron multiplication operation is performed for a number of times (e.g., about 400 times) without reducing the electrons during transfer operations. This further improves the electron multiplication property (electron multiplication factor).

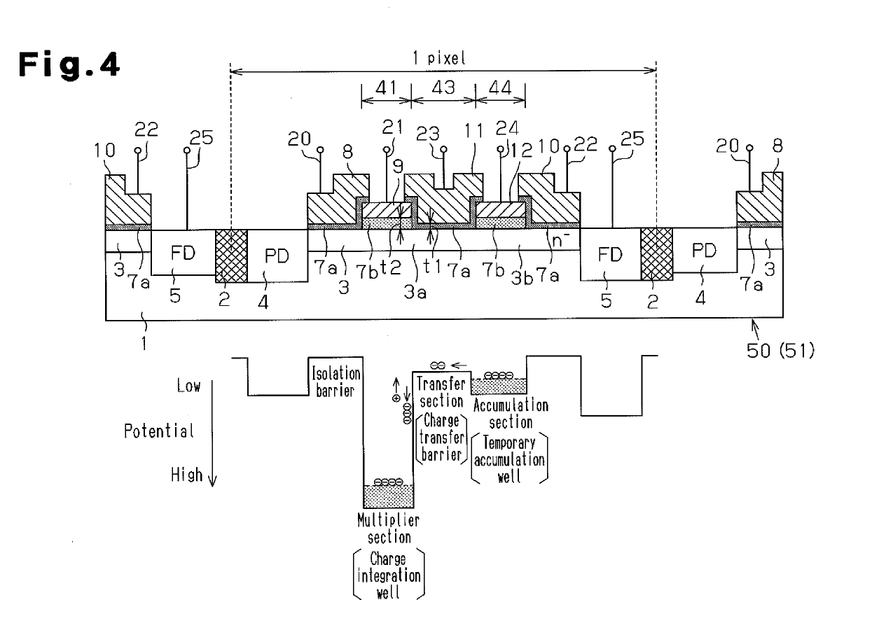

A second embodiment of a CMOS image sensor according to the present invention will now be discussed with reference to FIG. 4. In the second embodiment, a transfer gate electrode 11 transfers electrons multiplied at a high electric field region 3a under a multiplication gate electrode 9. Further, a transfer gate electrode 12 is formed between the transfer gate electrode 11 and read gate electrode 10 to transfer electrons via the read gate electrode 10 to the floating diffusion region 5. Further, an electron accumulation region 3h is arranged in a transfer channel 3 under the transfer gate electrode 12.

As shown in FIG. 4, a transfer gate electrode 8, the multiplication gate electrode 9, the transfer gate electrode 11, the transfer gate electrode 12, and the read gate electrode 10 are sequentially formed from the photodiode 4 toward the floating diffusion region 5 on the upper surface of the transfer channel 3 at predetermined intervals. The transfer gate electrode 8 is formed adjacent to the photodiode 4. The transfer gate electrode 8 is formed between the photodiode 4 and the multiplication gate electrode 9. The transfer gate electrode 11 is formed between the multiplication gate electrode 9 and the transfer gate electrode 12. The multiplication gate electrode 9 is formed at a side of the transfer gate electrode 12 opposite to the read gate electrode 10 and the floating diffusion region 5. The read gate electrode 10 is formed between the transfer gate electrode 12 and the floating diffusion region 5. Further, the read gate electrode 10 is formed adjacent to the floating diffusion region 5.

The transfer gate electrode 8, transfer gate electrode 11, and read gate electrode 10 are formed on the upper surface of the p-type silicon substrate 1 (the transfer channel 3) with a first insulation film 7a, which has thickness t1, formed in between. The multiplication gate electrode 9 and the transfer gate electrode 12 are formed on the upper surface of the p-type silicon substrate 1 (the transfer channel 3) with a second insulation film 7b, which has thickness t2, formed in between. The thickness t2 of the second insulation film 7b is greater than the thickness t1 of the first insulation film 7a. The first insulation film 7a and second insulation film 7b are formed in the same manner as in the first embodiment.

When a predetermined voltage (for example, 5.0 V) is applied, the transfer gate electrode 8 transfers the electrons produced by the photodiode 4 to the transfer channel 3 under the multiplication gate electrode 9. In a state in which voltage is not applied to the transfer gate electrode 8, the transfer gate electrode 8 functions as an isolation barrier that separates the photodiode 4 from a multiplier section 41 (the transfer channel under the multiplication gate electrode 9).

In a state in which a predetermined high voltage (voltage for generating an electric field that causes impact ionization of electrons, for example, about 24 V) is applied to the multiplication gate electrode 9, the transfer channel 3 under the multiplication gate electrode 9 is adjusted to a high potential. This forms the high electric field region 3a, to which a high electric field is applied, at the boundary between the transfer channel 3 under the transfer gate electrode 8 and the transfer channel 3 under the multiplication gate electrode 9. When the electrons accumulated in the photodiode 4 or an accumulation section 44 (the transfer channel 3 under the transfer gate electrode 12) during a multiplication operation are transferred and reach the high electric field region 3a, the high electric field generated in the high electric field region 3a causes impact ionization and multiplies the transferred electrons. The multiplication gate electrode 9, the second insulation film 7b, and the transfer channel 3 under the multiplication gate electrode 9 form the multiplier section 41.

When a predetermined voltage (for example, 5.0 V) is applied, the transfer gate electrode 11 functions to transfer the electrons accumulated in the transfer channel 3 under the multiplication gate electrode 9 (electron accumulation region 3b). The transfer gate electrode 11 also functions to transfer the electrons multiplied by the transfer channel 3 under the multiplication gate electrode 9 to the electron accumulation region 3b. The transfer gate electrode 11, the first insulation film 7a, and the transfer channel 3 under the transfer gate electrode 11 (electron accumulation region 3b) form a transfer section 43.

When a predetermined voltage (for example, 5.0 V) is applied, the transfer gate electrode 12 temporarily accumulates electrons in the transfer channel 3 under the multiplication gate electrode 9 (electron accumulation region 3b). The transfer gate electrode 12, the first insulation film 7a, and the transfer channel 3 under the transfer gate electrode 11 (electron accumulation region 3b) form the accumulation section 44.

When a predetermined voltage (for example, 5.0 V) is applied, the read gate electrode 10 transfers the charge signal of the electrons multiplied by the high electric field region 3a to the floating diffusion region 5 via the transfer gate electrode 12.

A peripheral circuit of the second embodiment includes a row selection register, a column selection register, and a signal processing circuit. In the same manner as the first embodiment, a selection transistor, a reset gate transistor, and a transistor of a source follower circuit are connected to an imaging portion. A MOS transistor as shown in FIG. 2B is used as each of these transistors (or each transistor in a signal processing circuit). Thus, in the same manner as in the first embodiment, the control gate electrode 16 of each transistor is formed on a substrate with a third insulation film 7c, which has a thickness t3 that is less than the thickness t1 of the first insulation film 7a, arranged in between and thereby functions to form a surface channel type transistor.

The electron multiplication operation of the CMOS image sensor in the second embodiment is performed by the multiplier section 41, the transfer section 43, and the accumulation section 44. On/off control is executed on the multiplication gate electrode 9, the transfer gate electrode 11, and the transfer gate electrode 12 to transfer electrons via the transfer channel 3 under the transfer gate electrode 11 between the transfer channel 3 under the multiplication gate electrode 9 (high electric field region 3a) and the transfer channel 3 under the transfer gate electrode 12 (electron accumulation region 3b).

The accumulation section 44 is one example of a “accumulation section” in the present invention, the transfer section 43 is one example of a “transfer section” in the present invention, the multiplier section 41 is one example of a “multiplier section” in the present invention, and the transfer gate electrode 11 is one example of a “first electrode” in the present invention.

The imaging device (CMOS image sensor) of the second embodiment has the following advantage in addition to the above-described advantages (1) to (6).

(7) The function (photodiode 44) for producing electrons through photoelectric conversion is separated from the function (accumulation section 44) for temporarily accumulating multiplied electrons. This separates electrons that are produced by light that erroneously enters the photodiode 4 during a multiplication operation. Thus, electrons are increased with a stable multiplication factor during multiplication operations.

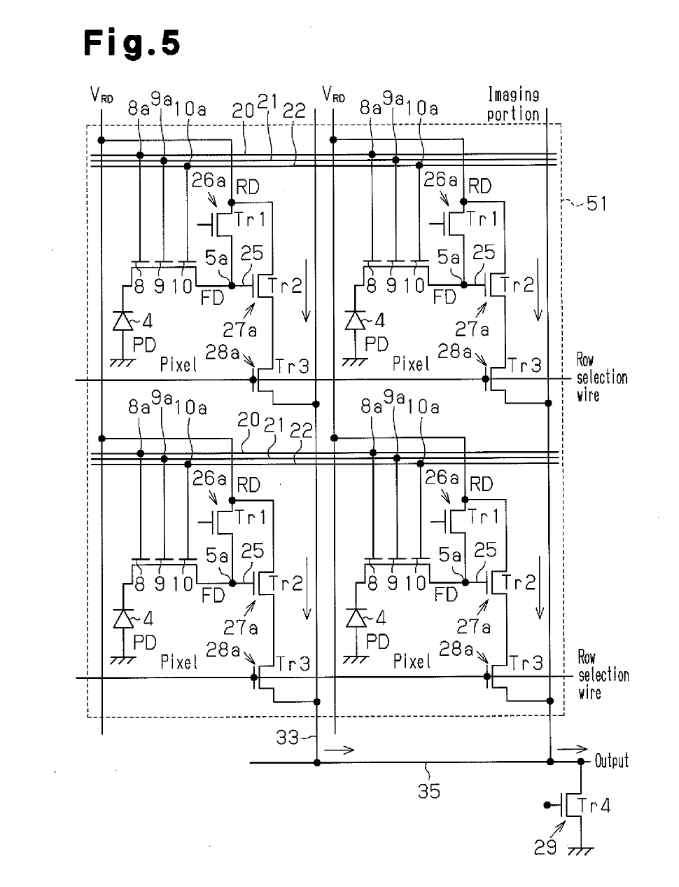

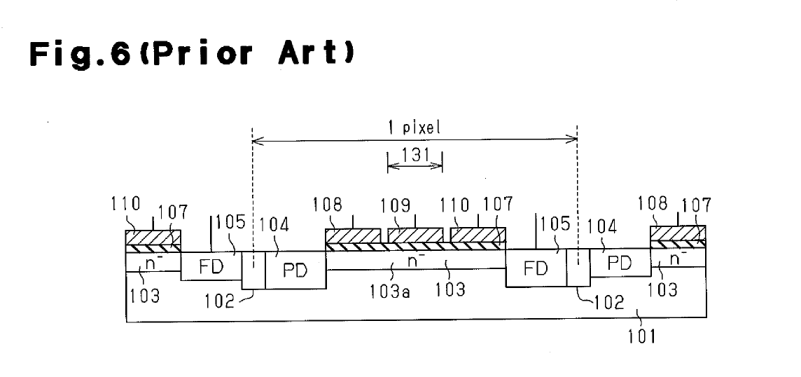

A third embodiment of a CMOS image sensor according to the present invention will now be discussed with reference to FIG. 5. The third embodiment differs from the first embodiment in the circuit of the row selection register and column selection register. More specifically, in the third embodiment, a reset gate transistor 26a, a voltage conversion transistor 27a, and a selection transistor 28a are provided for each pixel in the imaging portion 51. Further, a transistor 29 is arranged near the imaging portion 51 in the same manner as in the first embodiment. Otherwise, the third embodiment is the same as the first embodiment.

As shown in FIG. 5, the source of the reset gate transistor 26a (Tr1) is connected to a signal wire 25 in each pixel. The reset gate transistor 26a has a gate provided with a reset signal and a drain to which a reset voltage V_{RD} (about 5 V) is applied. After data is read from the pixel, the reset gate transistor 26a reset the voltage at the signal wire 25 to the reset voltage V_{RD} (about 5 V). Further, when data is read from the pixel, the reset gate transistor 26a holds the floating diffusion region 5 in an electrical floating state.

The signal wire 25 of each pixel is connected to the gate of the voltage conversion transistor 27a (Tr2). The source of the voltage conversion transistor 27a is connected to the drain of the selection transistor 28a (Tr3). The drain of the voltage conversion transistor 27a is supplied with power supply voltage (about 5 V, common with the reset voltage V_{RD}). The selection transistor 28a has a gate connected to a row selection wire and a source connected to a signal wire 33. The signal wire 33 for each column is connected to an output wire 35. The output wire 35 is connected to the drain of the single transistor 29 (Tr4). The transistor 29 has a source, which is connected to ground, and a gate, to which a predetermined voltage is applied so that the transistor 29 functions as a constant current source. The voltage conversion transistor 27a of each pixel and the single transistor 29 form a source follower circuit.

As described above, in the third embodiment, the reset gate transistor 26a, the voltage conversion transistor 27a, and the selection transistor 28a are arranged in the imaging portion 51. The transistor 29 is arranged near the imaging portion 51 (in a peripheral circuit).

A MOS transistor as shown in FIG. 2(B) is used as the transistor 29 in the peripheral circuit in the same manner as the first embodiment. A control gate electrode 16 of the transistor 29 is formed on a substrate with a third insulation film 7c, which has a thickness t3 that is less than the thickness t1 of the first insulation film 7a, arranged in between and thereby functions to form a surface channel type transistor. A signal processing circuit (not shown) is arranged near the imaging portion 51 (in the peripheral circuit). A MOS transistor (surface channel type transistor) that is the same as the transistor 29 is used as each transistor in the signal processing circuit.

The control gate electrode of each transistor in the imaging portion (i.e., the reset gate transistor 26a, the voltage conversion transistor 27a, and the selection transistor 28a) are formed on a substrate with the first insulation film, which has the thickness t1, arranged in between. The channel layer of such a transistor functions as an embedded channel.

In the CMOS image sensor of the third embodiment, data is read by repeating operations for applying a predetermined voltage (e.g., 2.5 V) to each of the above-described transistors at predetermined timings. For example, 5.0 V is applied to the reset gate transistor 26a, the voltage conversion transistor 27a, and the selection transistor 28a; and 2.5 V is applied to the transistor 29 and each transistor in the signal processing circuit.

The imaging device (CMOS image sensor) of the third embodiment has the following advantages in addition to the above-described advantages (1) to (6).

(8) The voltage conversion transistor 27a (Tr2) is arranged in each pixel for signal amplification. This reduces parasitic capacitance in the signal wire 25 extending from the floating diffusion region (FD) 5. Thus, the imaging device has a superior function for amplifying a signal charge and performs stable amplification.

(9) The voltage conversion transistor 27a (Tr2) is arranged in each pixel for signal amplification. Thus, the voltage conversion transistor is not shared with other pixels as in the first embodiment. This enables the extraction of any one of pixel signals. Thus, the signals of a plurality of pixels may be coupled, and the sensitivity of the CMOS image sensor may thereby be increased.

It should be apparent to those skilled in the art that the present invention may be embodied in many other specific forms without departing from the spirit or scope of the invention. Particularly, it should be understood that the present disclosure may be embodied in the following forms.

In each of the above-described embodiments, electrons are used as examples of signal charges. However, the present invention is not limited in such a manner. For example, electron holes may be used as the signal charges by reversing the conductance type of the substrate impurities and the polarity of the applied voltage. This would obtain the same advantages as the above-described embodiments. Accordingly, in this specification, signal charge refers to electrons and electron holes.

In each of the above-described embodiments, the imaging device is formed on the p-type silicon substrate. However, the present invention is not limited in such a manner. For example, an n-type silicon substrate on which a p-type impurity diffusion region is formed may be used as the substrate. This would obtain the same advantages as the above-described embodiments.

In each of the above-described embodiments, the second insulation film is a monolayer film of a thermal silicon oxide film (silicon oxide film formed through thermal oxidization). However, the present invention is not limited in such a manner. For example, the second insulation film may be a laminated layer film including a thermal silicon oxide film. In such a case, there are few defects in the thermal silicon oxide film (charge capturing portion). Thus, compared to a laminated layer film (or monolayer film) having the same thickness and being free of a thermal silicon oxide film, at least the above-described advantage (3) can be obtained.

In each of the above-described embodiments, the thickness of the third insulation film is less than the thickness of the first insulation film. However, the present invention is not limited in such a manner. For example, the third insulation film and the first insulation film may have the same thickness. In this case, at least the above-described advantages (2) and (4) are obtained.

In the second embodiment, the multiplier section, transfer section, and accumulation section are arranged sequentially from the photodiode to the floating diffusion region. However, the present invention is not limited in such a manner. For example, the positions of the multiplier section and accumulation section may be exchanged so that the accumulation section, transfer section, and multiplier section are arranged sequentially from the photodiode to the floating diffusion region. In this case, the same advantages as the above-described embodiments are obtained.

The present examples and embodiments are to be considered as illustrative and not restrictive, and the invention is not to be limited to the details given herein, but may be modified within the scope and equivalence of the appended claims.

What is claimed is:

1. An imaging device comprising:
an accumulation section which accumulates signal charges;
a transfer section which transfers the signal charges accumulated in the accumulation section; and
a multiplier section which increases the signal charges accumulated in the accumulation section, with the multiplier section being arranged opposite to the accumulation section from the transfer section;
wherein:
the transfer section includes a first insulating member arranged on a substrate and a first electrode arranged on the first insulating member;
the multiplier section includes a second insulating member arranged on the substrate and a second electrode arranged on the second insulating member; and
the second insulating member has a thickness which is greater than that of the first insulating member.

2. The imaging device according to claim 1, further comprising:
a transistor which controls an imaging portion including the accumulation section, transfer sections and multiplier section, wherein the transistor includes a gate insulation film which is thinner than the first insulating member.

3. The imaging device according to claim 2, wherein the transistor includes a surface channel type transistor having a channel layer in the surface of the substrate.

4. The imaging device according to claim 1, wherein the second insulating member includes a thermal silicon oxide film.

5. The imaging device according to claim 1, wherein the transfer section includes a transfer channel which functions as an embedded channel in the substrate when voltage is applied to the first electrode.

6. The imaging device according to claim 1, wherein the accumulation section and the multiplier section alternately repeat the transfer of signal charges from the accumulation section to the multiplier section to increase electrons and the transfer of signal charges from the multiplier section to the accumulation section.
